(19) United States
(12) Patent Application Publication
(10) Pub. No.: US 2025/0241245 A1
(43) Pub. Date: Jul. 31, 2025

(54) CAMERA SYSTEM FOR A SELF-PROPELLED FORAGE HARVESTER

(71) Applicant: CLAAS Selbstfahrende Erntemaschinen GmbH, Harsewinkel (DE)

(72) Inventors: Dennis Neitemeier, Lippetal (DE); Sven Carsten Belau, Gütersloh (DE); Ingo Bönig, Gütersloh (DE); Markus Brune, Harsewinkel (DE); Marwin Klein Heimkamp, Osnabrück (DE); Axel Jensen, Helsinge (DK); Hans Larsen, Hørsholm (DK)

(73) Assignee: CLAAS Selbstfahrende Erntemaschinen GmbH, Harsewinkel (DE)

(21) Appl. No.: 19/041,048

(22) Filed: Jan. 30, 2025

(30) Foreign Application Priority Data
Jan. 30, 2024 (DE) 102024102603.0

(51) Int. Cl. A01D 75/00; A01D 90/10; B60R 1/00; G06V 10/141; G06V 10/147

(52) U.S. Cl. CPC A01D 75/00; A01D 90/10; B60R 1/002; G06V 10/141; G06V 10/147; B60Y 2200/222; G06V 2201/06

(57) ABSTRACT

A forage harvester with a camera system. The camera system is configured to detect and evaluate a harvested material flow processed by working units of the forage harvester. The harvested material flow comprises whole grains, and comminuted grains as grain components and non-grain components. The camera system comprising an image sensor and an objective arranged or positioned upstream from the image sensor. The image sensor, arranged or positioned opposite the viewing window, is positioned in a housing which is arranged or positioned on a discharge chute of the forage harvester and in which a transparent viewing window is arranged or positioned, past which the harvested material flow flows. Light beams from a first light source are directed onto the harvested material flow. Further, an image analysis apparatus receives images from the image sensor of the harvested material flow for evaluation.

### CROSS REFERENCE TO RELATED APPLICATION

This application claims priority under 35 U.S.C. § 119 to German Patent Application No. DE 10 2024 102 603.0 filed Jan. 30, 2024, the entire disclosure of which is hereby incorporated by reference herein.

### TECHNICAL FIELD

The present invention relates to a camera system for a self-propelled forage harvester.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

U.S. Pat. No. 12,185,669, incorporated by reference herein in its entirety, discloses a camera system for a forage harvester. The camera system described therein comprises, as options for at least one camera to be used, a multispectral camera recording visible light and infrared light or a hyperspectral camera or an RGB camera in combination with an IR camera, each of which may transmit image data to an image analysis apparatus for evaluation. To record an image, a light source may illuminate a harvested material flow inside a discharge chute. The harvested material components of the harvested material flow may reflect the light, which may then pass through a semi-transparent mirror to the multispectral camera. Via an image recognition algorithm, grain components as well as non-grain components in the harvested material flow are detected.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a schematic and exemplary forage harvester.

FIG. 2a illustrates a schematic and exemplary perspective view of a camera system with hidden housing cover.

FIG. 2b illustrates a schematic and exemplary partial perspective view of the camera system according to FIG. 2a from the underside.

FIG. 3 illustrates a schematic and exemplary partial perspective view of a detail of a forage harvester discharge manifold with a camera system arranged or positioned thereon.

### DETAILED DESCRIPTION

As discussed in the background, the harvested material components of the harvested material flow reflect the light, which then passes through a semi-transparent mirror to the multispectral camera. However, the use of a mirror may be particularly susceptible to assembly errors since even the smallest impurities on the mirror or slight deviations from the intended position lead to faulty images from the camera system.

Thus, in one or some embodiments, a camera system is disclosed, which may be more economical and less complex structure (e.g., without the use of a mirror to route reflected light from the harvested material flow to the camera).

In one or some embodiments, a forage harvester is disclosed with a camera system that is configured to detect and evaluate a harvested material flow processed by one or more working units of the forage harvester. The harvested material flow may comprise any one, any combination, or all of: whole grains; comminuted grains; grain components; or non-grain components. The camera system may comprise an image sensor, an objective arranged or positioned upstream from the image sensor, and at least one light source (e.g., a first light source) configured to direct light beams onto the harvested material flow. The image sensor itself may be arranged or positioned at least partly within a housing (such as entirely within the housing). Further, the housing may be arranged or positioned on a discharge chute of the forage harvester and in which a viewing window (e.g., transparent and/or translucent and/or through which one or more wavelengths of light is transmitted) is arranged or positioned, past which the harvested material flow flows. The image sensor may generate and transmit one or more images of the harvested material flow to an image analysis apparatus for evaluation. The image sensor may be arranged or positioned opposite the viewing window. In one or some embodiments, this arrangement may have the advantage that the camera system is mirrorless and therefore may be less susceptible to installation errors and may have an overall more compact design.

In one or some embodiments, the image sensor may be designed as a CMOS or CCD image sensor. The image sensor may record images at a frame rate in the range of 20 images/second to 40 images/second, wherein the exposure time may be between 2 microseconds and 20 microseconds, and the objective has a focal length of between 2 mm and 12 mm (e.g., between 7 mm and 10 mm). In one or some embodiments, the objective is an optical element that gathers light from the object being observed and focuses the light rays to produce a real image. The objective may comprise a single lens, or may comprise several optical elements (e.g., a plurality of lenses). The objective may also be called object lenses, object glasses, or objective glasses.

In one or some embodiments, one consideration may be to optimally adapt the design of the image sensor of the camera system as well as the parameters used for the recording of images by the image sensor to the conditions prevailing in the discharge chute, such as the flow speed of the harvested material flow after exiting a secondary shredding device, which may be within a range of 15 m/s to 20 m/s. With the preferred parameterization of the image sensor of the camera system, an image analysis method for the computer-implemented determination of the degree of grain cracking of grains within the harvested material flow processed within the working units of the forage harvester may be performed using the image analysis apparatus of the camera system, which may enable the differentiation of grain components and non-grain components with the required accuracy for this and, based on this, the differentiation between whole grains and crushed grains by optical sifting. The required accuracy of the differentiation of grain components and non-grain components, and the differentiation between whole grains and crushed grains by the image analysis method may be based on a predetermined coefficient of determination. Furthermore, the use of a CMOS image sensor may be particularly suitable for use in the mirrorless camera system arranged or positioned on the discharge chute due to its fast readout and flat design. Overall, with the CMOS image sensor, the camera system may be designed to be flat such that the overall structure of the forage harvester does not exceed the permissible overall height when the discharge chute is in the folded in state.

In one or some embodiments, the camera system comprises a second light source, wherein the first light source and second light source are arranged or positioned opposite each other on the side next to the viewing window and the image sensor inside the housing. Two light sources may enable uniform illumination of the harvested material flow passing the viewing window.

In one or some embodiments, the objective may have an image angle in the range from 20° to 40°, such as in the range from 32° to 37°.

In one or some embodiments, the round viewing window may have a visible diameter which may be detected by the objective and which is greater than 7 cm and smaller than 13 cm. In an alternative embodiment, the viewing window may be designed rectangular with side lengths between 8 cm and 18 cm. The proposed range for the diameter or the side lengths of the viewing window may be relevant with regard to the requirement for the frame rate in order to ensure the demand for accuracy for the evaluation by the image analysis apparatus. Although the frame rate may be reduced with increasing diameter, the increase in the area of the viewing window may lead to increasing demands on the durability of the viewing window. Due to the arrangement of the viewing window in the discharge chute of the forage harvester, it may be permanently exposed to the harvested material flow and may be subjected to stresses due to the contact pressure exerted by the harvested material flow.

In one or some embodiments, the viewing window may comprise (or consist of) sapphire glass or a glass with a wear-resistant coating (e.g., a CVD diamond coating). Sapphire glass may be particularly suitable for use in the discharge chute due to its strength, wear resistance and high transparency.

In particular, the housing may be arranged or positioned on the upper side of the discharge chute, whereby the housing may be arranged or positioned in the second half of the discharge chute in relation to its longitudinal extension. This position of the housing may ensure that the transverse distribution of the chopped material covers the entire width of the discharge chute. The second half may be understood to be the half of the discharge chute facing away from the forage harvester. A position close to the finishing device may lead to less stringent conditions with regard to the overall height of the housing of the camera system, but, in one or some embodiments, since the lower part of the ejection chute is approximately orthogonal to the direction of travel in the raised position during harvesting operation, the inside of the ejection chute may initially be only partially covered with chopped material. A position in the rear segment of the discharge chute therefore may lead to maximum lateral distribution and lower harvested material speeds of the chopped material.

In particular, the camera system may have a control unit for controlling the light source(s), such as one or both of the first light source or the second light source. Matrix LED spotlights or laser diodes may be used as light sources.

In one or some embodiments, the control unit, configured to control the light source(s), may be arranged or positioned in the housing.

In one or some embodiments, the light sources are arranged or positioned at least partly within the housing (such as entirely within the housing). In one or some embodiments, any one, any combination, or all of the following may be at least partly (or entirely) within the housing: the image sensor; the objective; and the light source(s). Thus, a common arrangement of the components of the camera system, including each of the image sensor, the objective, and the light source(s), in the housing may enable a particularly compact design.

In one or some embodiments, the viewing window projecting into the discharge chute may be arranged or positioned on the inside of the discharge chute substantially flush (e.g., at least 90% flush, at least 95% flush, at least 96% flush, at least 97% flush, at least 98% flush, at least 99% flush) or entirely flush with its surface. For example, the viewing window may be glued into an essentially ring-shaped holder so that it is flush with the inside surface of the discharge chute, thereby minimizing influences on the harvested material flow. The ring-shaped holder may have a round or rectangular contour. With the arrangement of the viewing window glued into an annular holder, the necessary edge support surface may be taken into account in the visible diameter of the viewing window detectable through the objective, which may be effective in picking up the harvested material flow.

In one or some embodiments, the thickness of the viewing window may be within a range between 2 mm and 4 mm.

In one or some embodiments, the distance between the light source and the center of the viewing window may be between 50 mm and 120 mm, such as between 80 mm and 100 mm, and the light source may be arranged or positioned at an angle of between 20° and 45°, such as at an angle of between 35° and 40°, to the surface of the viewing window. This may create indirect lighting to prevent reflections.

In one or some embodiments, the image analysis apparatus may be arranged or positioned inside the housing since this may require particularly high computing power to process the images, and the data processing equipment usually available in the forage harvester does not meet this requirement.

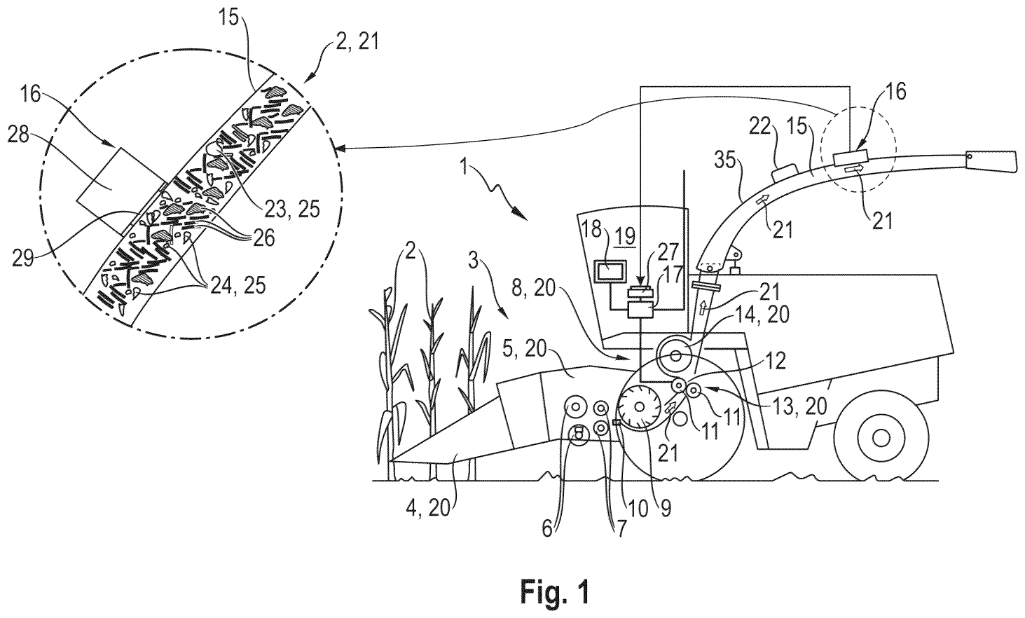

Referring to the figures, FIG. 1 shows, schematically and by way of example, a forage harvester 1 while harvesting a crop of plants, such as corn plants 2, on a field. Example forage harvesters are disclosed in US Patent Application Publication No. 2023/0232740 A1, US Patent Application Publication No. 2024/0196796 A1, or US Patent Application Publication No. 2024/0237580 A1, each of which is incorporated by reference herein in their entirety. A pick-up device 3 of the forage harvester 1 comprises, in a manner known per se, an attachment 4 which may be exchanged to be adapted to the plant material to be harvested, and a pulling-in apparatus 5 with several pairs of rollers 6, 7 which may take the harvested material from the attachment 4 in order to feed it to a chopping device 8.

The chopping device 8 may comprise a rotationally driven cutterhead 9, a shear bar 10 over which the corn plants 2 are pushed by the adjacent pair of rollers 7 of the pulling-in apparatus 5 in order to be chopped by the interaction of the shear bar 10 with the cutter-head 9. Downstream from the chopping device 8 may be a secondary crushing device 13, also referred to as a corn cracker, with a pair of conditioning or cracker rollers 11, which delimit a gap 12 of adjustable width, hereinafter also referred to as the cracker gap, and rotate at different speeds in order to crush corn kernels contained in the material stream passing through the gap 12. A post accelerator 14 (or secondary accelerator) may give the shredded harvested material, such as the corn plants 2, conditioned in the secondary crushing device 13, the necessary speed to pass through a discharge chute 15 and be transferred to an accompanying vehicle (not shown). The discharge chute 15 may have an essentially rectangular cross-section along its lengthwise extension. In one or some embodiments, the discharge chute 15 has a continuous closed upper side 35 and a partially open underside. Side walls may be arranged or positioned orthogonally to the upper side 35 of the discharge chute 15, which may laterally delimit and guide a harvested material flow 21 (illustrated by arrows) conveyed through the discharge chute 15.

In one or some embodiments, at least one camera system 16 is arranged or positioned on the discharge chute 15 in order to generate one or more images of the harvested material flow 21 conveyed through the discharge chute 15. Furthermore, an NIR sensor 22 may be arranged or positioned on the discharge chute 15. The NIR sensor 22 may be used to determine harvested material properties. In one or some embodiments, the NIR sensor 22 may be positioned here and/or upstream from the camera system 16 on the upper side of the discharge chute 15.

Any one, any combination, or all of the attachment 4, the pulling-in apparatus 5, the chopping device 8, the secondary crushing device 13 and the post accelerator 14 and their particular components may comprise working units 20 of the forage harvester 1, which may serve to harvest the corn plants 2 of a crop and/or to process the corn plants 2 of the crop within the context of the harvesting process.

Within the harvested material flow 21 processed by the working units 20 of the forage harvester 1 are whole grains 23 and crushed grains 24 as grain components 25 and non-grain components 26, such as stalks, leaves and the like.

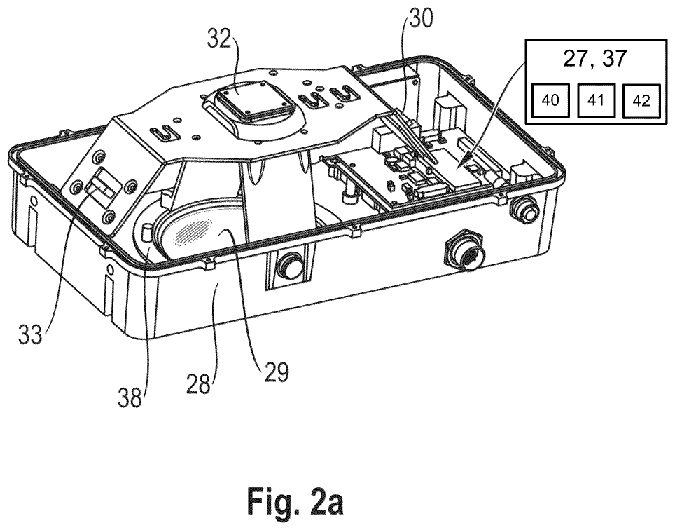

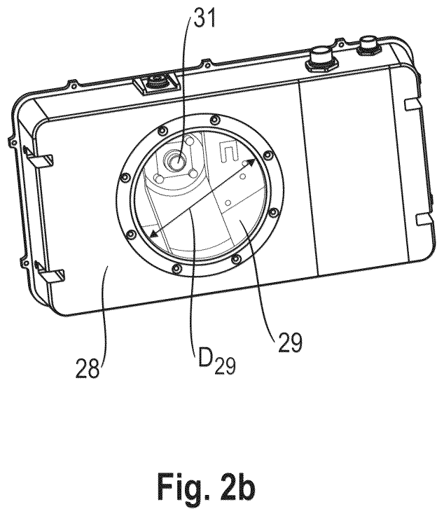

In one or some embodiments, the camera system 16 may have an image sensor 32 (see FIG. 2a) for recording image data of the crop material contained in the harvested material flow 21. The image sensor 32 may record spatially resolved image data. The term “spatially resolved” may mean that it is possible to distinguish details of the harvested material in the image data. The image sensor 32 therefore may have at least a sufficient number of pixels to enable the disclosed image analysis, which is explained further below. In a measurement routine, the camera system 16 may capture image data of the harvested material in the harvested material flow 21 (e.g., the chopped corn plants 2) using the image sensor 32. In one or some embodiments, this measuring routine may correspondingly be performed while the forage harvest 1 is operating.

The images generated by the camera system 16 may be transmitted to an image analysis apparatus 27 and analyzed thereby.

In one or some embodiments, the image analysis apparatus 27 is connected to (e.g., in communication with) a driver assistance system 17 or may be designed as a component of the driver assistance system 17 (e.g., integrated within the driver assistance system 17). However, in one or some embodiments, the image analysis apparatus 27 may be arranged or positioned within the housing 28 of the camera system 16 since this may require a particularly large computing power to process the image data of the image sensor, and the control or data processing units usually present in the forage harvester 1 may not meet this requirement. The driver assistance system 17 may be connected to (e.g., in communication with) an input/output unit 18 (e.g., a touchscreen) in a driver's cab 19 of the forage harvester 1 in order to output evaluation results thereto. The driver assistance system 17 may automatically control at least one actuator for adjusting any one, any combination or all of: the gap width of the cracker gap 12; the differential rotational speed; or the rotational speed levels of the rollers 11 of the secondary crushing device 13. In this regard, responsive to the image analysis apparatus 27 automatic analysis of the harvested material flow (including analysis of percentages of and/or amounts of and/or relative amounts of any one, any combination, or all of the whole grains, the comminuted grains; the grain components, or the non-grain components), which may be provided to the driver assistance system 17, the driver assistance system 17 may automatically modify operation of at least a part of the forage harvester 1 (such as modifying any one, any combination or all of: the gap width of the cracker gap 12; the differential rotational speed; or the rotational speed levels of the rollers 11 of the secondary crushing device 13), in order to modify the harvested material flow (e.g., modifying percentages of and/or amounts of and/or relative amounts of any one, any combination, or all of the whole grains, the comminuted grains; the grain components, or the non-grain components).

In one or some embodiments, the rollers 11 of the secondary crushing device 13 each rotate during operation at a speed settable as a parameter, wherein the gap 12 may remain between the rollers with a gap width settable as a parameter. Furthermore, the rollers 11 may have a rotational speed difference that may be set as a parameter, by which the rotational speeds of the rollers 11 may differ. Thus, in one or some embodiments, the driver assistance system 17 may be configured to automatically control at least one of the parameters depending on a degree of grain cracking to be determined (e.g., the image analysis apparatus 27 may automatically determine a degree of cracking; responsive to the driver assistance system 17 automatically determining that the determined degree of cracking is different from a predetermined degree of cracking, the driver assistance system 17 may automatically control the at least one of the parameters so that the degree of cracking is closer to (or equals) the determined degree of cracking).

The background to the automatic control of the secondary crushing device 13 depending on the degree of grain cracking may be particularly important when the harvested material is used as feed for animals and when used in biogas plants for the grain components 25 of the harvested material to be cracked (e.g., comminuted). It may be important to crack the grain components 25 to at least a predetermined amount so that the starch contained therein becomes accessible and is not protected by the husk of the grain component 25. The cracking of grain components 25 may be accomplished on the one hand by chopping up the harvested material and on the other hand substantially by the secondary crushing device 13. The secondary crushing device 13 may be set so that all the grain components 25 contained in the harvested material flow 21 are definitely chopped, which may be accompanied by increased consumption of energy or fuel. Accordingly, to achieve a maximum comminution and accordingly a high processing quality of the grain components 25, the gap width may be automatically adjusted (e.g., automatically adjusted to a minimum). This unnecessarily high consumed energy therefore cannot be converted into an increase in the driving speed so that a system-related, correspondingly reduced output per area results.

The camera system that is used in a method for computer-implemented automatic determination of the degree of grain cracking is explained in more detail below. Images of the harvested material flow 21 automatically taken cyclically by the camera system 16 are automatically transmitted to the image analysis apparatus 27 for evaluation using an image analysis method. The camera system 16 shown in more detail in FIGS. 2a and 2b has an objective 31 in front of the image sensor 32 and a first light source 33 and a second light source 30. The image sensor 32 has a field of view in which it may detect light reflected from the harvested material flow 21. The image sensor 32, the objective 31, the first light source 33, and the second light source 30 are arranged or positioned in a housing 28 of the camera system 16, which is attached to the top of the discharge chute 15. A viewing window 29, which may be translucent and/or transparent, is arranged or positioned on the side of the housing 28 facing the discharge chute 15. The viewing window 29 may comprise (or consist) of sapphire glass. In an alternative embodiment, however, the viewing window 29 may also comprise (or consist of) glass with a wear-resistant coating of CVD diamond.

The housing 28 of the camera system 16 (arranged or positioned on the upper side of the discharge chute 15) may be arranged or positioned in the second half of the discharge chute 15 in relation to its longitudinal extension.

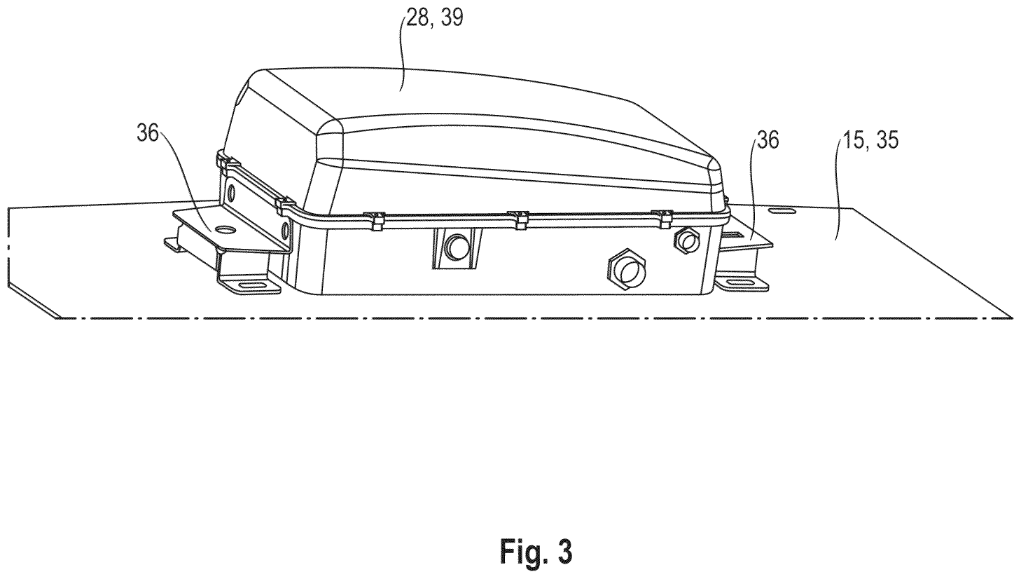

FIG. 3 shows a schematic and exemplary partial perspective view of a detail of the upper side 35 of the discharge chute 15 with the camera system 16 arranged or positioned thereon. The housing 28 is detachably attached to the upper side 35 of the discharge chute 15 by means of one or more mounting devices, such as two mounting devices 36. In contrast to the illustration in FIG. 2a, the housing cover 39 is shown here. An opening is provided in the upper side 35 of the discharge chute 15, into which the viewing window 29 is recessed tightly flush with the surface of the upper side 35 facing the harvested material flow 21. In one or some embodiments, the viewing window 29 and the opening are designed substantially circular. Alternatively, the viewing window 29 and the opening may be designed rectangular. The viewing window 29 may be glued or clamped into a substantially annular holder 38 (see FIG. 2a). The holder 38 may be fixed in the housing 28. The holder 38 may be detachably attached to the housing 28.

The viewing window 29 may have a visible diameter D29 that may be detected by the objective 31 and is greater than 7 cm and less than 13 cm. In one or some embodiments, the viewing window 29 may have a detectable visible diameter D29, which may be greater than or equal to 9 cm and less than or equal to 12 cm. In an alternative embodiment, the viewing window 29 may have a rectangular design, wherein the side lengths of the rectangularly designed viewing window 29 are greater than or equal to 8 cm and less than or equal to 18 cm. In the case of a rectangular design of the viewing window 29, the visible diameter D29 that may be detected through the objective 31 is taken into account by the respective edge length.

With the arrangement of the viewing window in the holder 38, the necessary edge support surface may be taken into account in the visible diameter D29 of the viewing window 29 detectable through the objective 31, which may be effective when picking up the harvested material flow. The visible diameter D29 of the viewing window 29 that may be detected through the objective 31 limits the field of vision.

In one or some embodiments, the thickness of the viewing window 29 may be within a range between 2 mm and 4 mm. The thickness of the viewing window 29 may essentially depend on the overall diameter D or the edge lengths in the case of a rectangular design of the viewing window 29.

The image sensor 32 may take pictures of the harvested material flow 21 at a frame rate within a range of 20 frame/second to 40 frame/second. In one or some embodiments, the image sensor is designed as a CMOS image sensor 32 since such a sensor may be particularly suitable for recording and processing such a frame rate and has a flat structure. Alternatively, or additionally, however, the image sensor 32 may also be designed as a CCD sensor. The exposure time here may be between 2 microseconds and 20 microseconds. The objective 31 used to record the images may have a focal length of between 2 mm and 12 mm. In one or some embodiments, the focal length is 3 mm. Furthermore, the objective 31 may have an image angle within a range from 20° to 40°. In the embodiment depicted, the image angle is 30°.

The camera system may have a control unit 37 for controlling the at least one light source (such as first light source 33 and/or second light source 30).

Any one, any combination, or all of the driver assistance system 17, the image analysis apparatus 27 or the control unit 37 may include at least one processor 40, at least one memory 41, and at least one communication interface 42. The at least one processor 40 and at least one memory 41 may be in communication (e.g., wired and/or wirelessly) with one another. In one or some embodiments, the processor 41 may comprise a microprocessor, controller, PLA, or the like. Similarly, the memory 41 may comprise any type of storage device (e.g., any type of memory). Though the processor 40 and the memory 41 are depicted as separate elements, they may be part of a single machine, which includes a microprocessor (or other type of controller) and a memory. Alternatively, the processor 40 may rely on the memory 41 for all of its memory needs. Still alternatively, the processor 40 may rely on a database for some or all of its memory needs. The memory 41 may comprise a tangible computer-readable medium that include software that, when executed by the processor 40 is configured to perform any one, any combination, or all of the functionality described herein, such as automatically controlling the lighting, automatically determining the contents of the harvested material flow, or automatically controlling one or more operations of the forage harvester 1. Further, the communication interface 42 may be configured to communicate (e.g., wired and/or wirelessly) with one or more electronic devices. As one example, the communication interface 42 of the image analysis apparatus 27 may be used to communicate with the driver assistance system 17.

The processor 40 and the memory 41 are merely one example of a computational configuration for the electronic devices discussed herein. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

In one or some embodiments, the control unit 37 for controlling the at least one light source (such as first light source 33 and/or second light source 30) may be arranged or positioned in the housing 28. In one or some embodiments, the control unit 37 and the image analysis apparatus 27 may be designed as a common component. In one or some embodiments, a first light source 33 and a second light source 30 for illuminating the harvested material flow 21 are arranged or positioned within the housing 28. Accordingly, the light beams of the first light source 33 and the second light source 30 are directed towards the harvested material flow 21. The first light source 33 and the second light source 30 may be positioned laterally next to the viewing window 29 and the image sensor 32 opposite one another. The use of the first light source 33 and the second light source 30 may be particularly advantageous in order to achieve uniform illumination of the harvested material flow 21 passing through the viewing window 29. Matrix LED spotlights or laser diodes may be used as the first light source 33 and the second light source 30.

In one or some embodiments, the distance between the first light source 33 and the second light source 30 and the center of the viewing window 29 may be between 50 mm and 120 mm in each case. The first light source 33 and the second light source 30 may each be arranged or positioned inclined at an angle of between 20° and 45° to the surface of the viewing window 29. In the embodiment depicted, the distance between the first light source 33 and the second light source 30, and the center of the viewing window 29 is 91.5 mm in each case, wherein the first light source 33 and the second light source 30 are designed as LED panels and are each inclined at an angle of 38° to the surface of the viewing window 29.

The images provided by the image sensor 32 may be transmitted to the image analysis apparatus 27 for automatic evaluation. Using the image analysis apparatus 27, an image analysis method may be performed for computer-implemented determination of the degree of grain cracking of grains within the harvested material flow 21 processed by the working units 20, in particular the secondary crushing device 13 of the forage harvester 1. At least one working unit 20, such as the secondary crushing device 13, may be automatically controlled depending on the degree of grain cracking. The image analysis method may comprise: in a first stage, image pixels contained in the images are classified into grain components 25 and non-grain components 26 by means of digital image processing; and in a second stage, a length determination of a long main axis and a short main axis of each classified grain component 25 is performed by means of a length-width comparison (e.g., the processor compares the respective lengths and widths), wherein the implementation of the first stage and the second stage of the image analysis method may be performed by at least one neural network.

The at least one neural network may be a component of the image analysis apparatus 27 and/or the driver assistance system 17. In particular, the neural network may be designed in the form of a U-Net architecture of a convolutional neural network or as a recurrent neural network.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

| | |
|---|---|
| 1 | Forage harvester |
| 2 | Corn plant |
| 3 | Pick-up device |
| 4 | Front attachment |
| 5 | Pulling-in apparatus |
| 6 | Roller pair |
| 7 | Roller pair |
| 8 | Chopping device |
| 9 | Cutterhead |
| 10 | Shear bar |
| 11 | Conditioning or cracker roller |
| 12 | Gap |
| 13 | Secondary crushing device |
| 14 | Post accelerator |
| 15 | Discharge chute |
| 16 | Camera system |
| 17 | Driver assistance system |
| 18 | Input/output unit |
| 19 | Driver's cab |
| 20 | Work unit |
| 21 | Harvested material flow |
| 22 | NIR sensor |
| 23 | Whole grains |
| 24 | Crushed grains |
| 25 | Grain component |
| 26 | Not grain component |
| 27 | Image analysis apparatus |
| 28 | housing |
| 29 | Window |
| 30 | Second light source |
| 31 | Objective |
| 32 | Image sensor |
| 33 | First light source |
| 34 | Field of vision |
| 35 | Top side of 15 |
| 36 | Mounting device |
| 37 | Control unit |
| 38 | Holder |
| 39 | Housing cover |
| 40 | Processor |
| 41 | Memory |
| 42 | Communication Interface |
| D₂₉ | Diameter |

1. A forage harvester comprising:
one or more working units;
a discharge chute; and
a camera system configured to detect and evaluate a harvested material flow processed by the one or more working units, wherein the harvested material flow comprises whole grains, comminuted grains as grain components and non-grain components, the camera system comprising:
an image sensor;
an objective positioned upstream, with regard to the harvested material flow, from the image sensor; and
at least one light source configured to generate light beams onto the harvested material flow;
wherein the image sensor is positioned at least partly in a housing;
wherein the housing is positioned on the discharge chute and in which a viewing window is positioned, past which the harvested material flow flows;
wherein the image sensor is positioned opposite the viewing window; and
wherein the image sensor is configured to generate and transmit one or more images of the harvested material flow to an image analysis apparatus.

2. The forage harvester of claim 1, wherein the viewing window and the image sensor, positioned opposite to one another, have no mirror therebetween;
wherein the image sensor comprises a CMOS or CCD image sensor;
wherein the image sensor is configured to record images at a frame rate in a range of 20 images/second to 40 images/second;
wherein exposure time is between 2 microseconds and 20 microseconds; and
wherein the objective has a focal length of between 2 mm and 12 mm.

3. The forage harvester of claim 2, wherein the objective has a focal length of between 7 mm and 10 mm.

4. The forage harvester of claim 1, wherein the at least one light source comprises a first light source and a second light source; and
wherein the first light source and second light source are positioned opposite each other on a side next to the viewing window and the image sensor inside the housing.

5. The forage harvester of claim 4, wherein a distance between the first light source and the second light source to a center of the viewing window is, in each case, between 50 mm and 120 mm; and
wherein the first light source and the second light source are each inclined at an angle of between 20° and 45° to a surface of the viewing window.

6. The forage harvester of claim 4, wherein a distance between the first light source and the second light source to a center of the viewing window is, in each case, between 80 mm and 100 mm; and
wherein the first light source and the second light source are each inclined at an angle of between 35° and 40° to a surface of the viewing window.

7. The forage harvester of claim 1, wherein the objective has an angle of view in a range from 20° to 40°.

8. The forage harvester of claim 1, wherein the objective has an angle of view in a range from 32° to 37°.

9. The forage harvester of claim 1, wherein the viewing window is round with a diameter that is greater than 7 cm and less than 13 cm.

10. The forage harvester of claim 1, wherein the viewing window is rectangular with side lengths between 8 cm and 18 cm.

11. The forage harvester of claim 1, wherein the viewing window consists of sapphire glass or glass with a wear-resistant coating.

12. The forage harvester of claim 11, wherein the wear-resistant coating comprises a coating of CVD diamond.

13. The forage harvester of claim 1, wherein the housing is positioned on an upper side of the discharge chute; and
wherein the housing is positioned in a second half of the discharge chute with respect to a longitudinal extension thereof.

14. The forage harvester of claim 1, wherein the camera system includes a control unit configured to control the at least one light source.

15. The forage harvester of claim 14, wherein the control unit is positioned within the housing.

16. The forage harvester of claim 1, wherein the viewing window projecting into the discharge chute is positioned on an inside of the discharge chute substantially flush with a surface thereof.

17. The forage harvester of claim 16, wherein a thickness of the viewing window is in a range between 2 mm and 4 mm.

18. The forage harvester of claim 1, wherein the image analysis apparatus is positioned inside the housing.
